(19) United States
(12) Patent Application Publication
(10) Pub. No.: US 2002/0196114 A1
(43) Pub. Date: Dec. 26, 2002

(54) Superconducting magnet support structure

(76) Inventors: Stephen R. Elgin II, Florence, SC (US); Michael L. Allford, Florence, SC (US); Michael R. Eggleston, Florence, SC (US)

Correspondence Address: ARTZ & ARTZ, P.C., 28333 TELEGRAPH RD., SUITE 250, SOUTHFIELD, MI, 48034, US

(21) Appl. No.: 09/681,888

(22) Filed: Jun. 20, 2001

(51) Int. Cl. H01F 5/00

(52) U.S. Cl. 335/299

(57) ABSTRACT

A superconducting magnet support structure and a method of fabricating the same are provided. The superconducting magnet support structure having a solid body comprises an exterior side, an interior portion, and an interior side. The superconducting magnet support structure is formed by performing a wet winding process thereby winding fiber cloth onto a preformed support tooling, curing the fiber cloth, and removing the preformed support tooling from the superconducting magnet support structure. The method of fabricating the superconducting magnet support structure of the present invention provides versatility allowing it to be applied to various MRI systems with varying superconducting magnet dimensions and geometries.

### BACKGROUND OF INVENTION

The present invention relates generally to a superconducting magnet support structure and more particularly, to a method and apparatus for supporting a superconducting magnet in a Magnetic Resonance Imager (MRI) System.

Currently Magnetic Resonance Imager (MRI) systems have included a superconducting magnet that generates a temporally constant primary magnetic field. The superconducting magnet is used in conjunction with a magnetic gradient coil assembly, which is sequentially pulsed to create a sequence of controlled gradients in the static magnetic field during a MRI data gathering sequence. The superconducting magnet and the magnetic gradient coil assembly have a radio frequency (RF) shield disposed therebetween. The RF shield controls eddy currents induced in the superconducting magnet by the changing magnetic flux produced by the magnetic gradient coil assembly. The controlled sequential gradients are effectuated throughout a patient imaging volume (patient bore) which is coupled to at least one MRI (RF) coil or antennae. The RF coils are located between the magnetic gradient coil assembly and the patient bore.

As a part of a typical MRI, RF signals of suitable frequencies are transmitted into the patient bore. Nuclear magnetic resonance (nMR) responsive RF signals are received from the patient bore via the RF coils. Information encoded within the frequency and phase parameters of the received RF signals, by the use of a RF circuit, is processed to form visual images. These visual images represent the distribution of nMR nuclei within a cross-section or volume of the patient within the patient bore.

In current MRI systems, the superconducting magnet includes a plurality of superconducting magnet coils and is supported by a superconducting magnet support structure within a toroidal helium vessel. When the superconducting magnet quits carrying a charge or current, quench forces result causing the superconducting magnet coils to move. The superconducting magnet support structure maintains the superconducting magnet coils tight and snug as to prevent movement.

In the production of current MRI systems, fiberglass cloth is used to build the superconducting magnet support structure. The superconducting magnet support structure is formed during a traditional wet winding process. During the traditional wet winding process, fiberglass is applied to and wound around a cylindrical shaped mandrel. Several layers of standard sized fiber cloth having a standard width are dipped into a liquid epoxy and applied to the mandrel. The fiberglass is allowed to cure to form a superconducting magnet support structure having a solid body. The superconducting magnet support structure is removed from the mandrel. Pockets are then cut in the exterior side of the superconducting magnet support structure to support the superconducting magnet. The dimensions and geometries of the pockets correspond to the dimensions and geometries of the superconducting magnet coils. Spacers remain between pockets in the superconducting magnet support structure to fill gaps between adjacent superconducting magnet coils. The closely matching dimensions and geometries allows the superconducting magnet support structure to maintain the superconducting magnet tight and snug as to prevent freedom of movement.

Superconducting magnet coils having non-standard dimensions may require pockets in the superconducting magnet support structure, which are deeper and narrower than standard pocket depths and widths. The nonstandard dimensions are more difficult to cut out then the standard dimensions. Specialized tooling and equipment would be necessary to possibly continue using the traditional wet winding process. Additionally, with specialized tooling and equipment increased cost and time would need to be incurred in order for the traditional process to be efficient and reliable. The difficulty level is sufficient and known to one skilled in the art, to cause the traditional process used to create the superconducting magnet support structure having non-standard dimensions to be infeasible and obsolete.

The traditional wet winding process is also unstable, inaccurate, and inefficient for the following reasons. The fiberglass cloth is free to move throughout the wet winding process causing voids and incorrect dimensions of the superconducting magnet support structure. These inaccuracies are increased for superconducting magnet support structure having non-standard dimensions. The voids are usually filled with epoxy. Extra time is thus required to rework the superconducting magnet support structures. The extra time increases costs.

It would therefore be desirable to provide a method of fabricating a superconducting magnet support structure in a MRI system that is more stable, accurate, efficient, and cost reductive relative to the current process used. It would also be desirable for the method to be adaptable for various non-standard geometries and dimensions of the superconducting magnet.

### SUMMARY OF INVENTION

It is therefore an object of the present invention to provide a method of fabricating a superconducting magnet support structure for a magnetic resonance imager (MRI) system that is adaptable for various non-standard geometries and dimensions of a superconducting magnet.

In one aspect of the present invention a method of fabricating a superconducting magnet support structure is provided. The method of fabricating the superconducting magnet support structure includes designing a preformed support tooling. After the preformed support tooling is designed it is fabricated. Fiber cloth is applied to the preformed support tooling by performing a wet winding process to form the superconducting magnet support structure. The fiber cloth is then cured. The superconducting magnet support structure is removed from the preformed support tooling.

In a further aspect of the present invention, a superconducting magnet support structure having a solid body is provided. The superconducting magnet support structure includes an exterior side, an interior portion, and an interior side. The exterior side has a plurality of spacers and a plurality of pockets. The plurality of spacers and the plurality of pockets have dimensions corresponding to dimensions of a superconducting magnet. The interior portion has a main body. The plurality of spacers are integrally connected to the external side of the main body.

One advantage of the present invention is that it provides versatility allowing it to be applied to various MRI systems with varying superconducting magnet dimensions and geometries. The versatility of the present invention increases accuracy, efficiency, and reduces costs in fabrication of the superconducting magnet support structure.

Another advantage of the invention, is the ability to vary the width of the fiberglass cloth. By varying the fiberglass cloth width, the correct final dimensions of the superconducting magnet support structure are achieved.

A further advantage of the present invention is that the preform support tooling stabilizes the wound fiberglass cloth to create accurate windings of the fiberglass cloth. The preform support tooling also provides a restraint to prevent layer-to-layer separation, which can create weak areas in the superconducting magnet support structure. The tooling also allows for larger radial builds, that are not possible using the traditional wet winding process.

The present invention itself, together with further objects and attendant advantages, is best understood by reference to the following detailed description, taken in conjunction with the accompanying drawing.

### BRIEF DESCRIPTION OF DRAWINGS

FIG. 1 is a block diagrammatic view of a magnetic resonance imager (MRI) system, utilizing a superconducting magnet support structure.

FIG. 2 is an enlarged, detailed cross-sectional view of a superconducting magnet support structure within a preformed support tooling constructed in accordance with a preferred embodiment of the present invention.

FIG. 3 is a flow chart illustrating a method for constructing a superconducting magnet support structure in accordance with a preferred embodiment of the present invention.

### DETAILED DESCRIPTION

The present invention is described herein with respect to an apparatus and a fabricating method for producing a superconducting magnet support structure. However, it will be understood that the following is capable of being adapted for various purposes and is not limited to the following applications; namely magnetic resonance imager (MRI) systems, magnetic resonance spectroscopy systems, and other applications that require use of a magnet support structure.

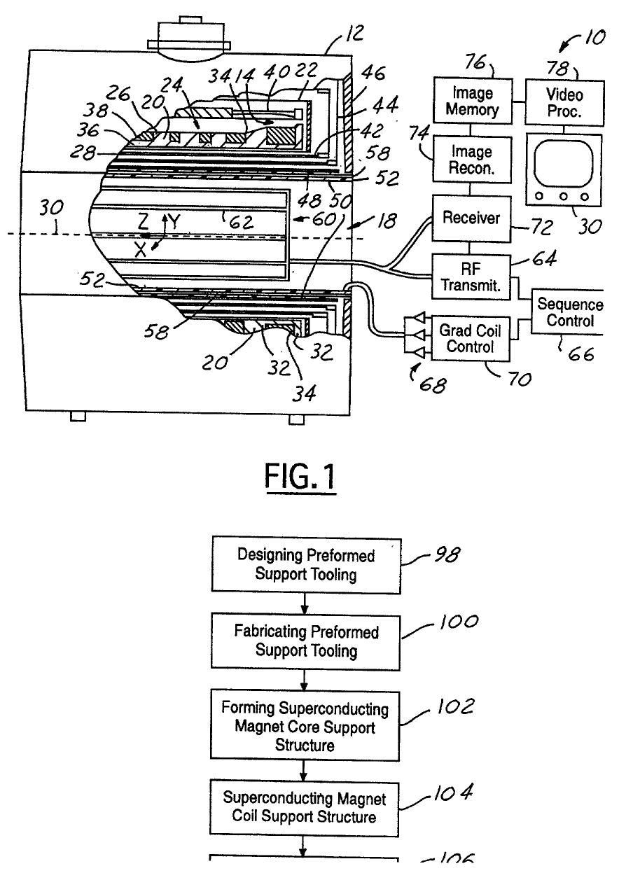

Referring now to FIG. 1, a block diagrammatic view of an MRI system 10. The MRI system 10 includes a static magnet structure 12 (a cylindrical structure) comprising a superconducting magnet 14 having a plurality of superconducting magnetic field coils 16 which generate a temporally constant magnetic field along a longitudinal axis (z-axis) of a central bore 18 (patient bore). The superconducting magnet coils 16 are supported by a superconducting magnet support structure 20 and received in a toroidal helium vessel or can 22. Only one superconducting magnet 14 and one superconducting magnet support structure 20 are shown, however, the disclosed system may have multiple superconducting magnets and superconducting magnet support structures.

The superconducting magnet support structure 20 is preferably a solid body and includes an exterior side 24, an interior portion 26, and an interior side 28.

The exterior side 24 is the longitudinal side farthest away from the center 30 of the patient bore 18 that supports the superconducting magnet 14. The exterior side 24 has a plurality of spacers 32 and a plurality of pockets 34. The plurality of spacers 32 and the plurality of pockets 34 have dimensions corresponding to dimensions of the superconducting magnet 14. The interior portion 26 is the solid body of the superconducting magnet support structure 20. The interior portion 26 has a main body 36. The plurality of spacers 32 are integrally connected to the external side 38 of the main body 36. The interior side 28 is preferably cylindrical shaped and is the side closest to the center 32 of the patient bore 14.

A main magnetic field shield coil assembly 40 generates a magnetic field that opposes the field generated by the superconducting magnet coils 16. A first coil shield 42 surrounds the helium vessel 22 to reduce boil-off. A second coil shield 44 surrounds the first coil shield 42. Both the first coil shield 42 and the second coil shield 44 are preferably cooled by mechanical refrigeration. The first coil shield 42 and the second coil shield 44 encases a toroidal vacuum vessel 46. The toroidal vacuum vessel 46 comprises a cylindrical member 48 that defines the patient bore 18 and extends parallel to a longitudinal axis. On a first exterior side 50 of the cylindrical member 48, which is longitudinal side farthest away from the center 30, of the patient bore 18 is a magnetic gradient coil assembly 52. Located on a second exterior side 54 of the magnetic gradient coil assembly 52 is a cylindrical dielectric former 56. A RF shield 58 is applied to the cylindrical dielectric former 56.

The patient bore 18 has a RF coil assembly 60 (antennae) mounted therein. The RF coil assembly 60 includes a primary RF coil 62 and the RF shield 58.

A RF transmitter 64 is connected to a sequence controller 66 and the primary RF coil 62. The RF transmitter 64 is preferably digital. The sequence controller 66 controls a series of current pulse generators 68 via a gradient coil controller 70 that is connected to the magnetic gradient coil assembly 52. The RF transmitter 64 in conjunction with the sequence controller 66 generates pulses of radio frequency signals for exciting and manipulating magnetic resonance in selected dipoles of a portion of the subject within the patient bore 18.

A radio frequency receiver 72 is connected with the primary RF coil 62 for demodulating magnetic resonance signals emanating from an examined portion of the subject. An image reconstruction apparatus 74 reconstructs the received magnetic resonance signals into an electronic image representation that is stored in an image memory 76. A video processor 78 converts stored electronic images into an appropriate format for display on a video monitor 80.

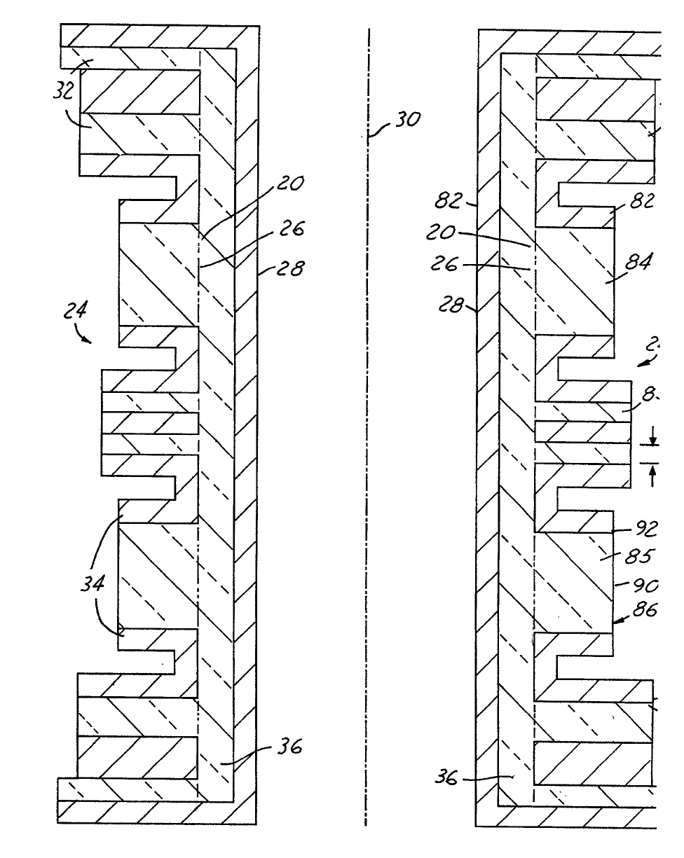

Referring now to FIG. 2, an enlarged detailed cross-sectional view of the superconducting magnet support structure 20 having the exterior side 24, the interior portion 26, and the interior side 28 is shown within a preformed support tooling 82.

The exterior side 24 comprises a plurality of spacers 32 and a plurality of pockets 34. Each spacer 84 of the plurality of spacers 32 occupies a space 85 located between two adjacent superconducting magnet coils 16. Each spacer 84 has a defined spacer height 86 and a defined spacer width 88. The spacer height 86 corresponds to a coil thickness of a particular coil of the plurality of superconducting magnet coils 16. The spacer height 86 is measured from an external side 38 of the main body 36 to an outer side 90 of the spacer 84. The spacer width 88 corresponds to a particular gap between superconducting magnet coils 16. Each pocket 92 of the plurality of pockets 34 holds a particular coil of the plurality of superconducting magnet coils 16. Each pocket 92 has a pocket depth 94 and a pocket width 96. Each pocket depth 94 is equal to the smallest adjacent spacer height 86 and corresponds to a coil thickness of a particular coil of the plurality of superconducting magnet coils 16 that is cupped by that pocket 92.

The preformed support tooling 82 is designed and fabricated to be used in a wet winding process so as to form the superconducting magnet support structure 20. The preformed support tooling is preferably fabricated out of carbon steel using a method known to one skilled in the art.

Referring now to FIG. 3, the superconducting magnet support structure 20 is preferably fabricated as discussed in detail below.

In step 98, the preformed support tooling 82 is designed. Initially, the design dimensions and geometries of the superconducting magnet 14 are determined. Thereafter, the dimensions of space available for the superconducting magnet support structure 20 in the toroidal helium vessel 22 are also determined. Based on the size of the superconducting magnet 14, a mounting configuration of the superconducting magnet support structure 20 is determined. The superconducting magnet support structure 20 is designed to accommodate for the dimensions and geometries of the superconducting magnet 14, the dimensions of space available, and the mounting configuration. The dimensions of the superconducting magnet support structure 20 are used to design the dimensions of the preformed support tooling 82.

In step 100, the preformed support tooling 82 is fabricated to match the dimensions determined for the preformed support tooling 20 in step 98. A mold release is built into or applied to the preformed support tooling 82 to ease in the removal of the preformed support tooling 82 from the superconducting magnet support structure 20.

In step 102, the superconducting magnet support structure 20 is formed. The superconducting magnet support structure 20 is formed using a wet winding process. During the wet winding process fiber cloth is dipped into a liquid epoxy and applied to the preformed support tooling 82 forming fiberglass layers. The fiber cloth is preferably an interlaced fabric having hoop fibers and axial fibers. The type of fiberglass preferably used is E (emissitivity) glass. The fiberglass cloth is wound around the preformed support tooling 82 and form layers of fiberglass on the preformed support tooling 82. The layers of fiberglass cloth add to form the superconducting magnet support structure 20.

Traditionally, standard width fiberglass cloth satisfies the geometries and dimensions of a standard superconducting magnet. On the other hand, the standard width of the fiberglass cloth does not satisfy a superconducting magnet having non-standard geometries and dimensions. As the standard width fiberglass cloth is wrapped around the preformed support tooling, for a MRI system having a non-standard superconducting magnet, each wrapping may overlap causing the final dimensions of the superconducting magnet support structure to deviate from the correct dimensions.

The present invention varies the width of the fiber cloth depending on the dimensions of the spacers 84 and pockets 92 for the area of the preformed support tooling 82 that the fiberglass is to be applied. The preform support tooling 82, stabilizes the positioning of the wound fiberglass cloth. The design of the tooling restricts where the fiberglass cloth can be applied. The restriction allows the wet winding process to be precise and accurate.

In step 104, the fiberglass layers are allowed to cure within the preformed support tooling 82. The preform support tooling provides a restraint to prevent layer-to-layer separation during curing, which can create weak areas in the superconducting magnet support structure.

In step 106, the preformed support tooling 82 is removed from the superconducting magnet support structure 20. Since the superconducting magnet support structure 20 has been formed within a tooling designed for a specific application, it does not require any reworking, unlike in the traditional wet winding process.

By varying the width of the fiber cloth and by taking advantage of the preformed support tooling 82 the present invention of fabricating the superconducting magnet support structure is a more accurate, stable, and efficient method, over the traditional wet winding process. Additionally, The present invention may be used to fabricate standard and non-standard sized superconducting magnets 14.

The above-described apparatus and manufacturing method, to one skilled in the art, is capable of being adapted for various purposes and is not limited to applications; including MRI systems, magnetic resonance spectroscopy systems, and other applications that require use of a magnet support structure. The above-described invention can also be varied without deviating from the true scope of the invention.

While particular embodiments of the invention have been shown and described, numerous variations alternate embodiments will occur to those skilled in the art. Accordingly, it is intended that the invention be limited only in terms of the appended claims.

1. A method of fabricating a superconducting magnet support structure comprising:
designing a preformed support tooling for the superconducting magnet support structure;
fabricating said preformed support tooling;
performing a wet winding process to form said superconducting magnet support structure;
curing said superconducting magnet support structure; and
removing said preformed support tooling from said superconducting magnet support structure.

2. A method as in claim 1 wherein the step of designing said preformed support tooling further comprising:
determining dimensions of the superconducting magnet;
determining dimensions of space available for said superconducting magnet support structure;
determining a mounting configuration of said superconducting magnet support structure;
designing dimensions of said superconducting magnet support structure to accommodate for said dimensions of said superconducting magnet, said dimensions of space available, and said mounting configuration; and designing dimensions of said preformed support tooling.

3. A method as in claim 1 wherein the step of performing a wet winding process further comprises applying a resin material onto said preformed support tooling.

4. A method as in claim 1 wherein the step of performing a wet winding process further comprises winding fiber cloth having strands of fiber onto said preformed support tooling.

5. A method as in claim 4 wherein the step of winding fiber cloth onto said preformed support tooling further comprises varying the widths of said fiber cloth.

6. A method as in claim 5 wherein the step of varying the widths of said fiber cloth comprises forming a plurality of spacers and a plurality of pockets.

7. A method as is claim 6 wherein the step of forming said plurality of spacers further comprises matching the dimensions and geometries of said plurality of spacers to the dimensions and geometries, respectively, of gaps between superconducting magnet coils.

8. A method as is claim 6 wherein the step of forming said plurality of pockets further comprises matching the dimensions and geometries of said plurality of pockets to the dimensions and geometries of said superconducting magnet.

9. A method as in claim 4 wherein the step of winding fiber cloth is performed by a computer numerically controlled (CNC) multi-axis winder.

10. A superconducting magnet support structure formed according to the method of claim 1.

11. A superconducting magnet support structure having a solid body comprising:
an exterior side having a plurality of spacers and a plurality of pockets wherein said plurality of spacers and plurality of pockets have dimensions corresponding to dimensions of a superconducting magnet;
an interior portion having a main body wherein said plurality of spacers are connected to said main body; and
an interior side;
wherein said exterior side, said interior portion, and said interior side comprises varying width material.

12. A system as claimed in claim 11 wherein said exterior side, said interior portion, and said interior side integrally forms a unitary solid body.

13. A system as claimed in claim 11 wherein said superconducting magnet support structure is formed from a plurality of fiber cloths having a variety of widths.

14. A system as claimed in claim 11 wherein said interior side is cylindrical shaped.

15. A system as claimed in claim 11 wherein a contour of said exterior side corresponds to a contour of the exterior side of a superconducting magnet.

16. A system as claimed in claim 11 wherein dimensions and geometries of said plurality of spacers corresponds to dimensions and geometries, respectively, of gaps between superconducting magnet coils.

17. A system as claimed in claim 11 wherein dimensions and geometries of said plurality of pockets corresponds to dimensions and geometries, respectively, of said superconducting magnet.

18. A system as claimed in claim 11 wherein said superconducting magnet support structure is toroidal shaped.

19. A system as claimed in claim 11 wherein said superconducting magnet support structure is formed from a resin.

20. A system as claimed in claim 11 wherein said superconducting magnet support structure has a hollow interior portion.
